(19) United States
(12) Patent Application Publication
(10) Pub. No.: US 2007/0091532 A1
(43) Pub. Date: Apr. 26, 2007

(54) Varistor

(76) Inventors: Mitsuyuki Yamauchi, Gunma (JP); Kazuyoshi Sato, Gunma (JP); Kentaro Fukuda, Gunma (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/584,437

(22) Filed: Oct. 20, 2006

(30) Foreign Application Priority Data
Oct. 21, 2005 (JP) 2005-306558

(51) Int. Cl. H02H 9/06

(52) U.S. Cl. 361/118

(57) ABSTRACT

In one inventive aspect, a varistor includes a plurality of sets laminated on top of one another, and each set has an inner conductor layer for grounding connected to an external electrode for grounding, a first ceramic layer with the inner conductor layer for grounding formed on a top surface thereof, an inner conductor layer for signal containing a leading portion connected to an external electrode for signal, and a second ceramic layer with the inner conductor layer for signal formed on a top surface thereof. The position of the leading portion is displaced in the plural sets so as not to overlap one on another in the lamination direction. When this configuration is adopted, the varistor becomes able to handle many more channels by merely increasing the number of the sets. Because the thickness of each layer is so thin that there is no influence on a reduction in size even when the number of the sets is increased. It is thus possible to provide a compact chip varistor that achieves a countermeasure against static electricity and removal of an unwanted radiation signal, and is thereby capable of handling a multi-channel signal line.

### BACKGROUND OF THE INVENTION

1. Field of the Invention

The present invention relates to a chip varistor, and more particularly, to a chip varistor having the filter effect.

2. Description of the Related Technology

In order to meet a request for a high-rate data transmission in recent years, the number of channels and the frequency has been increased for a signal line used to transmit a digital signal. To protect against static electricity in the signal line in the related art, a zener diode or a varistor is connected to the signal in parallel. On the other hand, as can be seen in today's mobile devices, various functions, such as a camera, the GPS (Global Positioning System), an FM radio, Bluetooth (registered trademark), and a TV set, that operate at different frequencies are incorporated into a single device. This situation raises a need to deal with EMC noises and remove an unwanted radiation signal by preventing interferences inside the device, and a device for filtering is used besides the varistor. Although a varistor having the filter effect has been developed, the device becomes undesirably thick.

JP-A-2005-223240 discloses a device capable of preventing damage to an electric circuit in a more reliable manner as a countermeasure against static electricity, and this device includes a varistor portion formed by laminating a ceramic layer and first and second inner conductors alternately, an inductor portion provided on the top surface of the varistor portion and having a coil conductor, a first external electrode for grounding connected to an end portion of the first inner conductor, a second external electrode connected to one of the end portions of the coil conductor, and a third external electrode connected to an end portion of the second inner conductor and the other end portion of the coil conductor. In this component as a countermeasure against static electricity, the varistor portion and the inductor portion functioning as the filter are completely separated by the layer, and this layer configuration is maintained when the array configuration is adopted. According to the configuration as described above, however, when a large number of circuits having the same performance are achieved by a single chip, the packaging area or the thickness or the both are undesirably increased.

As has been described, when the countermeasure against static electricity and the countermeasure against an unwanted radiation signal are performed simultaneously, the number of components and the packaging area are increased, which results in an increase in cost. In addition, there arises a problem that the thickness of a mobile device cannot be lessened.

### Summary of Certain Inventive Aspects

An advantage of certain inventive aspects is therefore to provide a compact chip varistor that achieves a countermeasure against static electricity and removal of an unwanted radiation signal, and is thereby capable of handling a multi-channel signal line.

A varistor includes plural first sets laminated on top of one another in a direction, and each set has an inner conductor layer for grounding connected to an external electrode for grounding, a first ceramic layer with the inner conductor layer for grounding formed on a top surface thereof, an inner conductor layer for signal containing a leading portion connected to an external electrode for signal, and a second ceramic layer with the inner conductor layer for signal formed on a top surface thereof, wherein a position of the leading portion is displaced in the plural first sets so as not to overlap one on another in the direction in which the plural first sets are laminated.

When the configuration as above is adopted, the varistor becomes able to handle many more channels by merely increasing the number of the first sets. In addition, a countermeasure against static electricity and removal of an unwanted radiation signal are enabled in response to a combination of the inner conductor layer for grounding, the ceramic layer, and the inner conductor layer for signal. Each layer is so thin that there is no influence on a reduction in size.

Also, it may be configured in such a manner that a surface on which is formed the external electrode for grounding and a surface on which is formed the external electrode for signal are orthogonal to each other. This configuration enables the varistor to handle many more channels by utilizing the outer surfaces thereof effectively.

In addition, it may be configured in such a manner that each set further has a second inner conductor layer for grounding connected to the external electrode for grounding and a third ceramic layer with the second inner conductor layer for grounding formed on a top surface thereof. It is thus possible to prevent interferences among channels by increasing the number of the inner conductor layers for grounding.

Further, it may be configured in such a manner that the inner conductor layer for signal includes a first inner conductor layer for signal containing a first leading portion connected to a first external electrode for signal, and a second inner conductor layer for signal containing a second leading portion connected to a second external electrode for signal within a same layer. This configuration enables the varistor to handle many more channels.

Furthermore, it may be configured in such a manner that one of a length and a width of a signal line in the inner conductor layer for signal is set in response to a height of the inner conductor layer for signal from a packaging surface of the varistor. When configured in this manner, the inductance can be made equal in the respective first sets, which makes it possible to suppress a variance of frequencies at which resonance is induced. To be more concrete, one of a length and a width of a signal line in the inner conductor layer for signal may be shorter as a height of the inner conductor layer for signal from one of a bottom surface and a top surface of the varistor becomes higher.

Moreover, it may be configured in such a manner that the varistor further includes plural second sets laminated on top of one another in a second direction opposite to the direction in which the plural first sets are laminated, and each second set has a second inner conductor layer for grounding connected to the external electrode for grounding, a third ceramic layer with the second inner conductor layer for grounding formed on a bottom surface thereof, a second inner conductor layer for signal including a second leading portion connected to the external electrode for signal, a fourth ceramic layer with the second inner conductor layer for signal formed on a bottom surface thereof. In this case, the position of the second leading portion is displaced in the plural second sets so as not to overlap one on another in the second direction. Further, the position of the second leading portion is set to coincide with the position of the corresponding leading portion in the first set, so that a sum of heights of the leading portion in the first set and the second leading portion from one of a top surface and a bottom surface of the varistor becomes equal for all combinations of the leading portion in the first set and the second leading portion. It is thus possible to suppress a variance of the characteristic in each external electrode.

### BRIEF DESCRIPTION OF THE DRAWINGS

FIG. 1 is a perspective view of a chip varistor according to a first embodiment of the invention;

FIG. 2 is an exploded perspective view of the chip varistor according to the first embodiment of the invention;

FIG. 3 is a view showing the frequency characteristic of the chip varistor according to the first embodiment of the invention;

FIG. 4 is a perspective view of a chip varistor according to a second embodiment of the invention;

FIG. 5 is an exploded perspective view of the chip varistor according to the second embodiment of the invention;

FIG. 6 is a perspective view of a chip varistor according to a third embodiment of the invention;

FIG. 7 is an exploded perspective view of the chip varistor according to the third embodiment of the invention;

FIG. 8 is a perspective view of a chip varistor according to a fourth embodiment of the invention;

FIG. 9 is an exploded perspective view of the chip varistor according to the fourth embodiment of the invention;

FIG. 10 is a perspective view of a chip varistor according to a fifth embodiment of the invention;

FIG. 11 is an exploded perspective view of the chip varistor according to the fifth embodiment of the invention;

FIG. 12 is a view schematically showing the side surface of a chip varistor according to a sixth embodiment of the invention;

FIG. 13 is an exploded perspective view of the chip varistor according to the sixth embodiment of the invention;

FIG. 14 is a view schematically showing the side surface of a chip varistor according to a seventh embodiment of the invention; and

FIG. 15 is a side view showing a modification of the chip varistor according to the seventh embodiment of the invention.

### DESCRIPTION OF CERTAIN ILLUSTRATIVE EMBODIMENTS

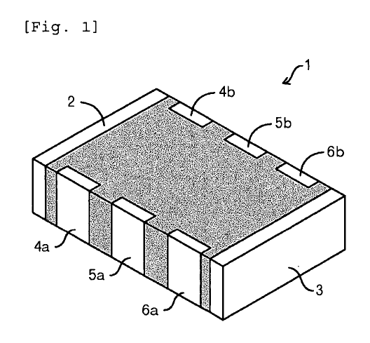

FIG. 1 is a perspective view of a chip varistor 1 according to a first embodiment. The chip varistor 1 is provided with external electrodes 2 and 3 for grounding formed respectively at the both ends in the longitudinal direction. External electrodes 4a and 4b for a first circuit, external electrodes 5a and 5b for a second circuit, and external electrodes 6a and 6b for a third circuit are formed on the side surfaces in the longitudinal direction.

The external electrodes 4a through 6b partially lie over the top surface of the chip varistor 1 (partially lie over the bottom surface in some cases). These lying over portions, however, are not necessarily required. The surface on which are formed the external electrodes 4a through 6b and the surfaces on which are formed the external electrodes 2 and 3 for grounding are orthogonal to each other, and by forming the external electrodes on separate surfaces in this manner, it is possible to utilize the outer surfaces of the chip varistor 1 effectively, which enables many more circuits to be incorporated therein.

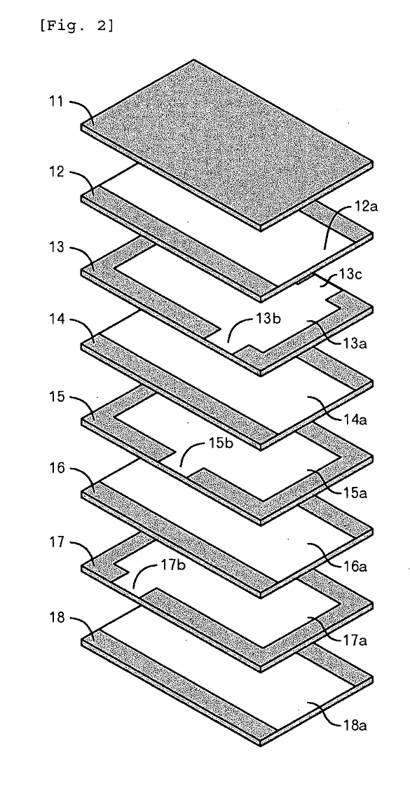

FIG. 2 is an exploded perspective view of the chip varistor 1. The chip varistor 1 of this embodiment includes, from top to bottom, an insulation layer 11, a ceramic layer 12 with an inner conductor 12a for grounding formed on the top surface thereof, a ceramic layer 13 with an internal conductor 13a serving as a low-impedance transmission line of the strip-line structure formed the top surface thereof, a ceramic layer 14 with an inner conductor 14a for grounding formed on the top surface thereof, a ceramic layer 15 with an inner conductor 15a serving as a low-impedance transmission line of the strip-line structure formed on the top surface thereof, a ceramic layer 16 with an inner conductor 16a for grounding formed on the top surface thereof, a ceramic layer 17 with an inner conductor 17a serving as a low-impedance transmission line of the strip-line structure on the top surface thereof, and a ceramic layer 18 with an inner conductor 18a for grounding formed on the top surface thereof.

A protection layer or the like may be provided on the insulation layer 11 and a protection layer or the like may be provided beneath the ceramic layer 18.

The inner conductors 12a, 14a, 16a, and 18a for grounding are connected to the external electrodes 2 and 3 for grounding at the both ends of the chip varistor 1 in the longitudinal direction. The inner conductor 13a is provided with leading portions 13b and 13c extending toward the side surfaces of the chip varistor 1 in the longitudinal direction. The leading portion 13b is connected to the external electrode 6a and the leading portion 13c is connected to the external electrode 6b. The inner conductor 15a is provided with leading portions 15b and 15c (15c is not shown) extending toward the side surfaces of the chip varistor 1 in the longitudinal direction. The leading portion 15b is connected to the external electrode 5a and the leading portion 15c (not shown) is connected to the external electrode 5b. Further, the inner conductor 17a is provided with leading portions 17b and 17c (17c is not shown) extending toward the side surfaces of the chip varistor 1 in the longitudinal direction. The leading portion 17b is connected to the external electrode 4a and the leading portion 17c (not shown) is connected to the external electrode 4b.

As has been described, the positions of the leading portions 13b through 17c are displaced to coincide with the locations of the external electrodes. This configuration makes it possible to dispose the external electrodes efficiently. Each of a set of the leading portions 13b and 13c, a set of the leading portions 15b and 15c, and a set of the leading portions 17b and 17c is provided on a straight line. Each set is provided on a straight line to align with the signal line to be connected. It is, however, possible to displace the extended positions of leading lines in each set with respect to each other instead of being aligned in a straight line where occasion demands. The positions are displaced one by one to coincide with the locations of the corresponding external electrodes. However, the positions are not necessarily displaced one by one.

It should be noted that the chip varistor 1 of this embodiment can be formed from materials same as those forming a multilayer chip varistor in the related art.

As has been described, in this embodiment, a compact chip varistor of the array configuration achieving a countermeasure against static electricity and removal of an unwanted radiation signal is realized by laminating one unit comprising the inner conductor for grounding, the ceramic layer, the inner conductor forming a transmission line, and the ceramic layer on top of one another.

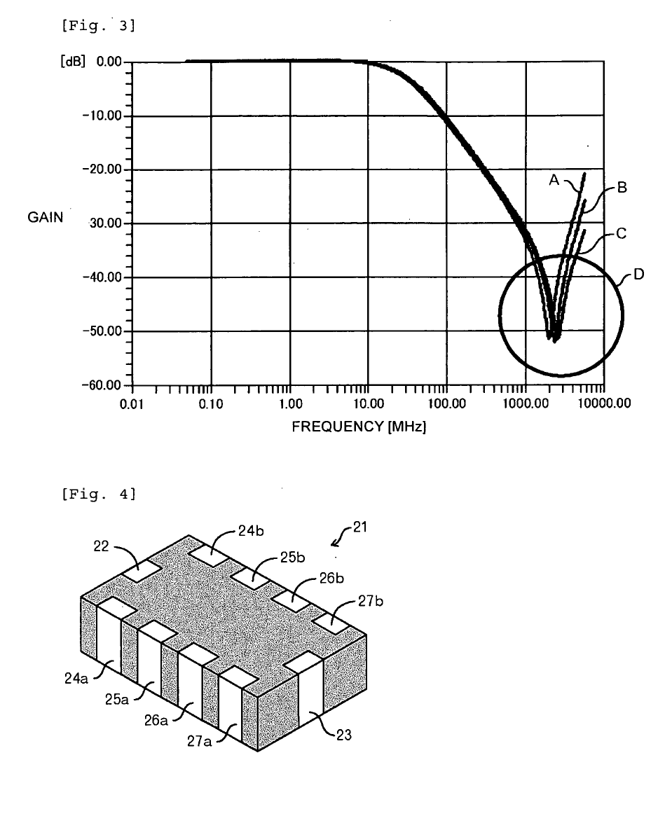

FIG. 3 shows the frequency characteristic of the chip varistor 1 having the structures shown in FIG. 1 and FIG. 2. In FIG. 3, the vertical axis is used for gain [dB] and the horizontal axis is used for frequencies [MHz]. In the example of FIG. 3, the gain starts to decrease at about 10 MHz and the gain reaches the minimum at 2 GHz to 3 GHz due to resonance. The gain increases in a frequency band higher than the frequencies specified above. The characteristic of a circuit between the external electrodes 4a and 4b is indicated by a curve A, the characteristic of a circuit between the external electrodes 5a and 5b is indicated by a curve B, and the characteristic of a circuit between the external electrodes 6a and 6b is indicated by a curve C. In the example of FIG. 3, the characteristics of the three circuits are almost identical, and a low-pass filter is formed. The chip varistor 1 also has the effect of the countermeasure against static electricity, which is normally provided to a varistor. The inside of a circle D in FIG. 3 indicates that resonance frequencies of the respective circuits vary slightly. This point will be described in sixth and seventh embodiments below.

A typical component of the multiple structure has a structure in which a large number of circuits formed by making a single circuit smaller are aligned side by side. However, in this embodiment, the component is formed by laminating a single-layer strip-line structure. It is thus possible to reduce the component in size, in particular, in height. To be more concrete, the thickness of each ceramic layer shown in FIG. 2 is as thin as 10 μm to 40 μm, and the chip varistor 1 can remain thin even when a large number of these ceramic layers are laminated. In addition, because the single-layer strip-line structure is adopted, the component is not formed of circuits made by making a single circuit smaller. It is thus possible to ensure a stable capacity sufficient for the area of base of the chip varistor 1. Also, because the single-layer strip-line structure is laminated in multiple layers, an excellent high-frequency characteristic can be achieved.

Further, by adjusting the electrostatic capacity, the shape, and the inductance capacity of the varistor, it is possible to design the frequency damping characteristic as desired without any limitation. In other words, the frequency damping characteristic can be designed according to the frequency of an unwanted radiation signal that needs to be removed.

Furthermore, because the countermeasure against static electricity and removal of an unwanted radiation signal are enabled by a single element, both the packaging area and the cost can be reduced.

The chip varistor 1 having the structures shown in FIG. 1 and FIG. 2 can be manufactured by the same technique for a typical multilayer ceramic varistor.

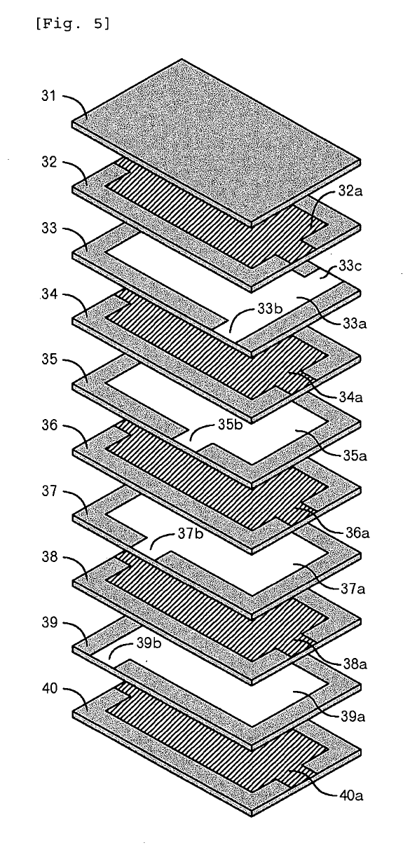

FIG. 4 and FIG. 5 show a chip varistor 21 according to a second embodiment. FIG. 4 is a perspective view of the chip varistor 21 of the second embodiment. The chip varistor 21 is provided with external electrodes 22 and 23 for grounding respectively at the both ends in the longitudinal direction. External electrodes 24a and 24b for a first circuit, external electrodes 25a and 25b for a second circuit, external electrodes 26a and 26b for a third circuit, and external electrodes 27a and 27b for a fourth circuit are formed on the side surfaces in the longitudinal direction.

FIG. 5 is an exploded perspective view of the chip varistor 21. The chip varistor 21 of this embodiment includes, from top to bottom, an insulation layer 31, a ceramic layer 32 with an inner conductor 32a for grounding formed on the top surface thereof, a ceramic layer 33 with an inner conductor 33a serving as a low-impedance transmission line of the strip-line structure formed on the top surface thereof, a ceramic layer 34 with an inner conductor 34a for grounding formed on the top surface thereof, a ceramic layer 35 with an inner conductor 35a serving as a low-impedance transmission line of the strip-line structure formed on the top surface thereof, a ceramic layer 36 with an inner conductor 36a for grounding formed on the top surface thereof, a ceramic layer 37 with an inner conductor 37a serving as a low-impedance transmission line of the strip-line structure formed on the top surface thereof, a ceramic layer 38 with an inner conductor 38a for grounding formed on the top surface thereof, a ceramic layer 39 with an inner conductor 39a serving as a low-impedance transmission line of the strip-line structure formed on the top surface thereof, and a ceramic layer 40 with an inner conductor 40a for grounding formed on the top surface thereof.

The inner conductors 32a, 34a, 36a, 38a, and 40a for grounding are connected to the external electrodes 22 and 23 for grounding at the both ends of the chip varistor 21 in the longitudinal direction. In the example of FIG. 5, the both ends of the inner conductors 32a, 34a, 36a, 38a, and 40a for grounding are tapered. However, they are not necessarily tapered. In addition, the inner conductor 33a is provided with leading portions 33b and 33c extending toward the side surfaces of the chip varistor 21 in the longitudinal direction. The leading portion 33b is connected to the external electrode 27a and the leading portion 33c is connected to the external electrode 27b. The inner conductor 35a is provided with leading portions 35b and 35c (35c is not shown) extending toward the side surfaces of the chip varistor 21 in the longitudinal direction. The leading portion 35b is connected to the external electrode 26a and the leading portion 35c (not shown) is connected to the external electrode 26b. Further, the inner conductor 37a is provided with leading portions 37b and 37c (37c is not shown) extending toward the side surfaces of the chip varistor 21 in the longitudinal direction. The leading portion 37b is connected to the external electrode 25a and the leading portion 37c (not shown) is connected to the external electrode 25b. Furthermore, the inner conductor 39a is provided with leading portions 39b and 39c (39c is not shown) extending toward the side surfaces of the chip varistor 21 in the longitudinal direction. The leading portion 39b is connected to the external electrode 24a and the leading portion 39c (not shown) is connected to the external electrode 24b.

It should be noted that the chip varistor 21 of this embodiment can be formed from materials same as those forming a multilayer chip varistor in the related art. Likewise, the chip varistor 21 having the structures shown in FIG. 4 and FIG. 5 can be manufactured by the same technique for a typical multilayer ceramic varistor.

As has been described, in this embodiment, one unit comprising the inner conductor for grounding, the ceramic layer, the inner conductor forming a transmission line, and the ceramic layer is laminated four times, which outnumbers the number of laminations in the first embodiments. However, as has been described above, because each layer is as thin as 10 to 40 μm, the overall thickness is not increased markedly.

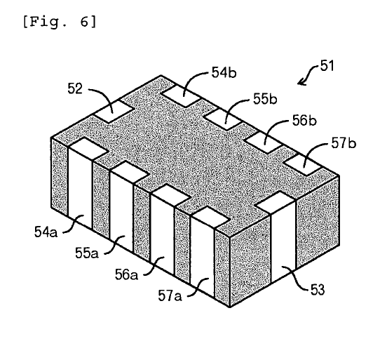

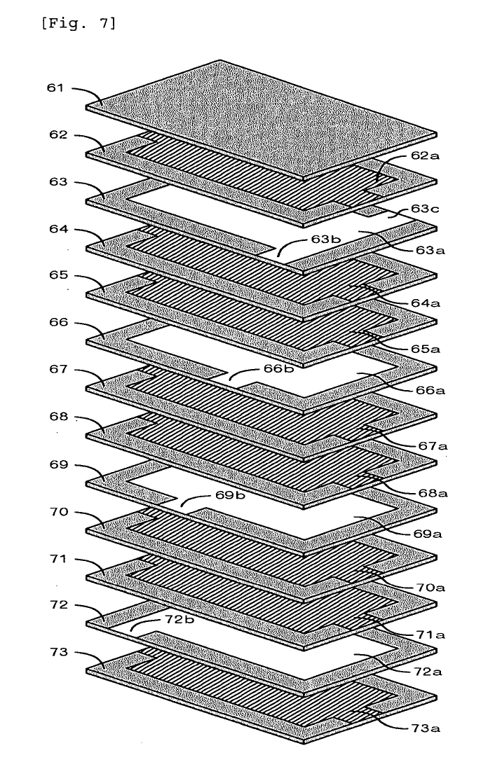

FIG. 6 and FIG. 7 show a chip varistor 51 according to a third embodiment. FIG. 6 is a perspective view of the chip varistor 51 of the third embodiment. The chip varistor 51 is provided with external electrodes 52 and 53 for grounding respectively at the both ends in the longitudinal direction. External electrodes 54a and 54b for a first circuit, external electrodes 55a and 55b for a second circuit, external electrodes 56a and 56b for a third circuit, and external electrodes 57a and 57b for a fourth circuit are formed on the side surfaces in the longitudinal direction.

FIG. 7 is an exploded perspective view of the chip varistor 51. The chip varistor 51 of this embodiment includes, from top to bottom, an insulation layer 61, a ceramic layer 62 with an inner conductor 62a for grounding formed on the top surface thereof, a ceramic layer 63 with an inner conductor 63a serving as a low-impedance transmission line of the strip-line structure formed on the top surface thereof, a ceramic layer 64 with an inner conductor 64a for grounding formed on the top surface thereof, a ceramic layer 65 with an inner conductor 65a for grounding formed on the top surface thereof, a ceramic layer 66 with an inner conductor 66a serving as a low-impedance transmission line of the strip-line structure formed on the top surface thereof, a ceramic layer 67 with an inner conductor 67a for grounding formed on the top surface thereof, a ceramic layer 68 with an inner conductor 68a for grounding formed on the top surface thereof, a ceramic layer 69 with an inner conductor 69a serving as a low-impedance transmission line of the strip-line structure formed on the top surface thereof, a ceramic layer 70 with an inner conductor 70a for grounding formed on the top surface thereof, a ceramic layer 71 with an inner conductor 71a for grounding formed on the top surface thereof, a ceramic layer 72 with an inner conductor 72a serving as a low-impedance transmission line of the strip-line structure formed on the top surface thereof, and a ceramic layer 73 with an inner conductor 73a for grounding formed on the top surface thereof.

The inner conductors 62a, 64a, 65a, 67a, 68a, 70a, 71a, and 73a for grounding are connected to the external electrodes 52 and 53 for grounding at the both ends of the chip varistor 51 in the longitudinal direction. In addition, the inner conductor 63a is provided with leading portions 63b and 63c extending toward the side surfaces of the chip varistor 51 in the longitudinal direction. The leading portion 63b is connected to the external electrode 57a and the leading portion 63c is connected to the external electrode 57b. The inner conductor 66a is provided with leading portions 66b and 66c (66c is not shown) extending toward the side surfaces of the chip varistor 51 in the longitudinal direction. The leading portion 66b is connected to the external electrode 56a and the leading portion 66c (not shown) is connected to the external electrode 56b. Further, the inner conductor 69a is provided with leading portions 69b and 69c (69c is not shown) extending toward the side surfaces of the chip varistor 51 in the longitudinal direction. The leading portion 69b is connected to the external electrode 55a and the leading portion 69c (not shown) is connected to the external electrode 55b. Furthermore, the inner conductor 72a is provided with leading portions 72b and 72c (72c is not shown) extending toward the side surfaces of the chip varistor 51 in the longitudinal direction. The leading portion 72b is connected to the external electrode 54a and the leading portion 72c (not shown) is connected to the external electrode 54b.

It should be noted that the chip varistor 51 of this embodiment can be formed from materials same as those forming a multilayer chip varistor in the related art. The chip varistor 51 having the structures shown in FIG. 6 and FIG. 7 can be manufactured by the same technique for a typical multilayer ceramic varistor.

As has been described, in this embodiment, one unit comprising the inner conductor for grounding, the ceramic layer, the inner conductor forming a transmission line, the ceramic layer, the inner conductor for grounding, and the ceramic layer is laminated four times. One layer of the inner conductor for grounding and one ceramic layer are added for each unit. Nevertheless, by increasing the inner conductors for grounding, it is possible to reduce interferences among transmission lines.

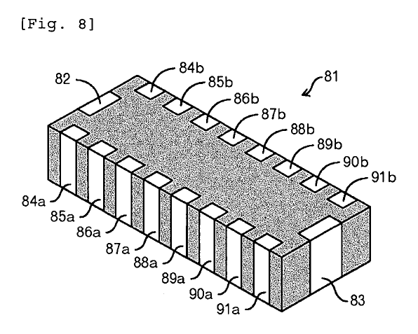

FIG. 8 and FIG. 9 show a chip varistor 81 according to a fourth embodiment. FIG. 8 is a perspective view of the chip varistor 81 of the fourth embodiment. The chip varistor 81 is provided with external electrodes 82 and 83 for grounding respectively at the both ends in the longitudinal direction. External electrodes 84a and 84b for a first circuit, external electrodes 85a and 85b for a second circuit, external electrodes 86a and 86b for a third circuit, external electrodes 87a and 87b for a fourth circuit, external electrodes 88a and 88b for a fifth circuit, external electrodes 89a and 89b for a sixth circuit, external electrodes 90a and 90b for a seventh circuit, and external electrodes 91a and 91b for an eighth circuit are formed on the side surfaces in the longitudinal direction.

FIG. 9 is an exploded perspective view of the chip varistor 81. The chip varistor 81 of this embodiment includes, from top to bottom, an insulation layer 101, a ceramic layer 102 with an inner conductor 102a for grounding formed on the top surface thereof, a ceramic layer 103 with inner conductors 103a and 103b serving as low-impedance transmission lines of the strip-line structure formed on the top surface thereof, a ceramic layer 104 with an inner conductor 104a for grounding formed on the top surface thereof, a ceramic layer 105 with an inner conductor 105a for grounding formed on the top surface thereof, a ceramic layer 106 with inner conductors 106a and 106b serving as low-impedance transmission lines of the strip-line structure formed on the top surface thereof, a ceramic layer 107 with an inner conductor 107a for grounding formed on the top surface thereof, a ceramic layer 108 with an inner conductor 108a for grounding formed on the top surface thereof, a ceramic layer 109 with inner conductors 109a and 109b serving as low-impedance transmission lines of the strip-line structure formed on the top surface thereof, a ceramic layer 110 with an inner conductor 110a for grounding formed on the top surface thereof, a ceramic layer 111 with an inner conductor 111a for grounding formed on the top surface thereof, a ceramic layer 112 with inner conductors 112a and 112b serving as low-impedance transmission lines of the strip-line structure formed on the top surface thereof, and a ceramic layer 113 with an inner conductor 113a for grounding formed on the top surface thereof.

The inner conductors 102a, 104a, 105a, 107a, 108a, 110a, 111a, and 113a for grounding are connected to the external electrodes 82 and 83 for grounding at the both ends of the chip varistor 81 in the longitudinal direction. In addition, the inner conductor 103a is provided with leading portions 103e and 103f (103f is not shown) extending toward the side surfaces of the chip varistor 81 in the longitudinal direction. The leading portion 103e is connected to the external electrode 84a and the leading portion 103f (not shown) is connected to the external electrode 84b. The inner conductor 103b is provided with leading portions 103c and 103d extending toward the side surfaces of the chip varistor 81 in the longitudinal direction. The leading portion 103c is connected to the external electrode 91a and the leading portion 103d is connected to the external electrode 91b. Further, the inner conductor 106a is provided with leading portions 106e and 106f (106f is not shown) extending toward the side surfaces of the chip varistor 81 in the longitudinal direction. The leading portion 106e is connected to the external electrode 85a and the leading portion 106f (not shown) is connected to the external electrode 85b. Furthermore, the inner conductor 106b is provided with leading portions 106c and 106d (106d is not shown) extending toward the side surfaces of the chip varistor 81 in the longitudinal direction. The leading portion 106c is connected to the external electrode 90a and the leading portion 106d (not shown) is connected to the external electrode 90b.

Further, the inner conductor 109a is provided with leading portions 109e and 109f (109f is not shown) extending toward the side surfaces of the chip varistor 81 in the longitudinal direction. The leading portion 109e is connected to the external electrode 86a and the leading portion 109f (not shown) is connected to the external electrode 86b. The inner conductor 109b is provided with leading portions 109c and 109d (109d is not shown) extending toward the side surfaces of the chip varistor 81 in the longitudinal direction. The leading portion 109c is connected to the external electrode 89a and the leading portion 109d (not shown) is connected to the external electrode 89b. In addition, the inner conductor 112a is provided with leading portions 112e and 112f (112f is not shown) extending toward the side surfaces of the chip varistor 81 in the longitudinal direction. The leading portion 112e is connected to the external electrode 87a and the leading portion 112f (not shown) is connected to the external electrode 87b. The inner conductor 112b is provided with leading portions 112c and 112d (112d is not shown) extending toward the side surfaces of the chip varistor 81 in the longitudinal direction. The leading portion 112c is connected to the external electrode 88a and the leading portion 112d (not shown) is connected to the external electrode 88b.

In the example of FIG. 9, the positions of the leading portions provided to the inner conductors serving as transmission lines are displaced sequentially from the upper layers from the both ends of the chip varistor 81 in the longitudinal direction to the inner side. Alternatively, the positions may be displaced from the upper layers in directions toward the both ends from the inner side, or the positions may be displaced from one of the ends of the chip varistor 81 in the longitudinal direction to the other end. In short, it is sufficient to displace the positions, and the rule of displacement is arbitrary.

It should be noted that the chip varistor 81 of this embodiment can be formed from materials same as those forming a multilayer chip varistor in the related art. The chip varistor 81 having the structures shown in FIG. 8 and FIG. 9 can be manufactured by the same technique for a typical multilayer ceramic varistor.

As has been described, in this embodiment, one unit comprising the inner conductor for grounding, the ceramic layer, the inner conductor forming a transmission line, the ceramic layer, the inner conductor for grounding, and the ceramic layer is laminated four times. Further, as is shown in FIG. 9, by dividing the circuit into halves in the longitudinal direction of the chip varistor 81, it is possible to double the number of circuits contained in a single chip. This configuration is particularly effective when the thickness of the chip varistor is limited.

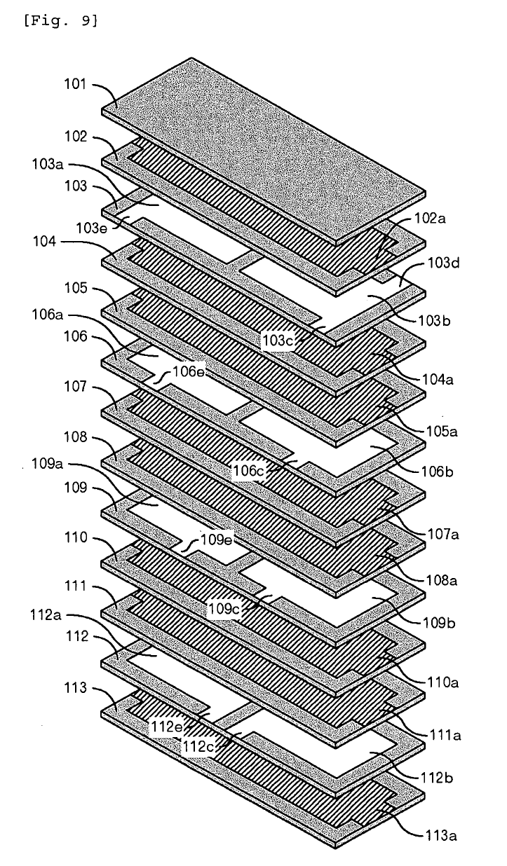

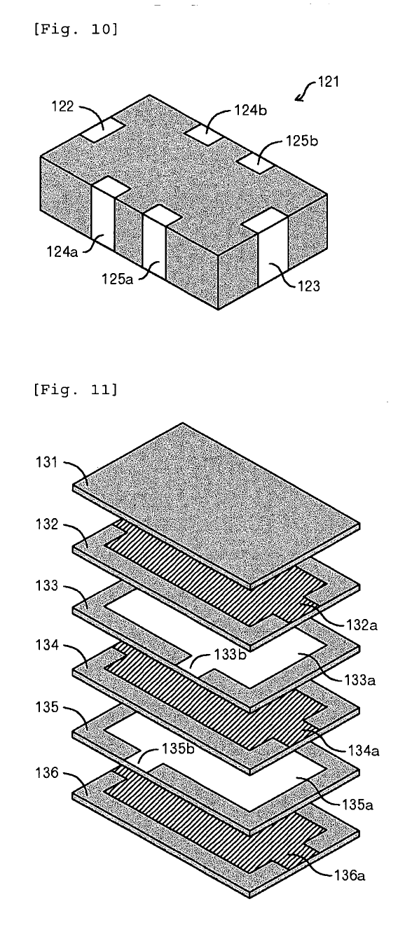

FIG. 10 and FIG. 11 show a chip varistor 121 according to a fifth embodiment. FIG. 10 is a perspective view of the chip varistor 121 of the fifth embodiment. The chip varistor 121 is provided with external electrodes 122 and 123 for grounding respectively at the both ends in the longitudinal direction. External electrodes 124a and 124b for a first circuit and external electrodes 125a and 125b for a second circuit are formed on the side surfaces in the longitudinal direction.

FIG. 11 is an exploded perspective view of the chip varistor 121. The chip varistor 121 of this embodiment includes, from top to bottom, an insulation layer 131, a ceramic layer 132 with an inner conductor 132a for grounding formed on the top surface thereof, a ceramic layer 133 with an inner conductor 133a serving as a low-impedance transmission line of the strip-line structure formed on the top surface thereof, a ceramic layer 134 with an inner conductor 134a for grounding formed on the top surface thereof, a ceramic layer 135 with an inner conductor 135a serving as a low-impedance transmission line of the strip-line structure formed on the top surface thereof, and a ceramic layer 136 with an inner conductor 136a for grounding formed on the top surface thereof.

The inner conductors 132a, 134a, and 136a for grounding are connected to the external electrodes 122 and 123 for grounding at the both ends of the chip varistor 121 in the longitudinal direction. In addition, the inner conductor 133a is provided with leading portions 133b and 133c (133c is not shown) extending toward the side surfaces of the chip varistor 121 in the longitudinal direction. The leading portion 133b is connected to the external electrode 125a and the leading portion 133c (not shown) is connected to the external electrode 125b. The inner conductor 135a is provided with leading portions 135b and 135c (135c is not shown) extending toward the side surfaces of the chip varistor 121 in the longitudinal direction. The leading portion 135b is connected to the external electrode 124a and the leading portion 135c (not shown) is connected to the external electrode 124b.

It should be noted that the chip varistor 121 of this embodiment can be formed from materials same as those forming a multilayer chip varistor in the related art. The chip varistor 121 having the structures shown in FIG. 10 and FIG. 11 can be manufactured by the same technique for a typical multilayer ceramic varistor.

As has been described, in this embodiment, one unit comprising the inner conductor for grounding, the ceramic layer, the inner conductor forming a transmission line, and the ceramic layer is laminated two times. Two circuits are provided for a differential signal having one channel, and a low-height structure can be achieved.

FIG. 12 schematically shows the side surface of the chip varistor 21 shown in FIG. 4, for example. It should be noted that the external electrodes 24a through 27a have not been formed. As are shown in FIG. 5 and FIG. 12, the leading portion 33b is formed at the right end when viewed from the side surface, and a leading portion end 33e appears on the side surface so as to be connected to the external electrode 27a. Assume that the bottom surface of the chip varistor 21 is the packaging surface to the printed circuit board or the like, then, h₁ is the height of the leading portion end 33e from the packaging surface. Likewise, the leading portion 35b is formed second from the right when viewed from the side surface, and a leading portion end 35e appears on the side surface so as to be connected to the external electrode 26a. Hence, h₂ is the height of the leading portion end 35e from the packaging surface. The leading portion 37b is formed third from the right when viewed from the side surface, and a leading portion end 37e appears on the side surface so as to be connected to the external electrode 25a. Hence, h₃ is the height of the leading portion end 37e from the packaging surface. The leading portion 39b is formed at the left end when viewed from the side surface, and a leading portion end 39e appears on the side surface so as to be connected to the external electrode 24a. Hence, h₄ is the height of the leading portion end 39e from the packaging surface.

Herein, the relation expressed as h₁>h₂>h₃>h₄ is established. Because the height from the packaging surface differs from circuit to circuit as has been described, a total length of the leading line also differs from circuit to circuit. The inductance therefore varies in each circuit, which gives rise to a phenomenon that the resonance frequency varies for each circuit as shown in FIG. 3.

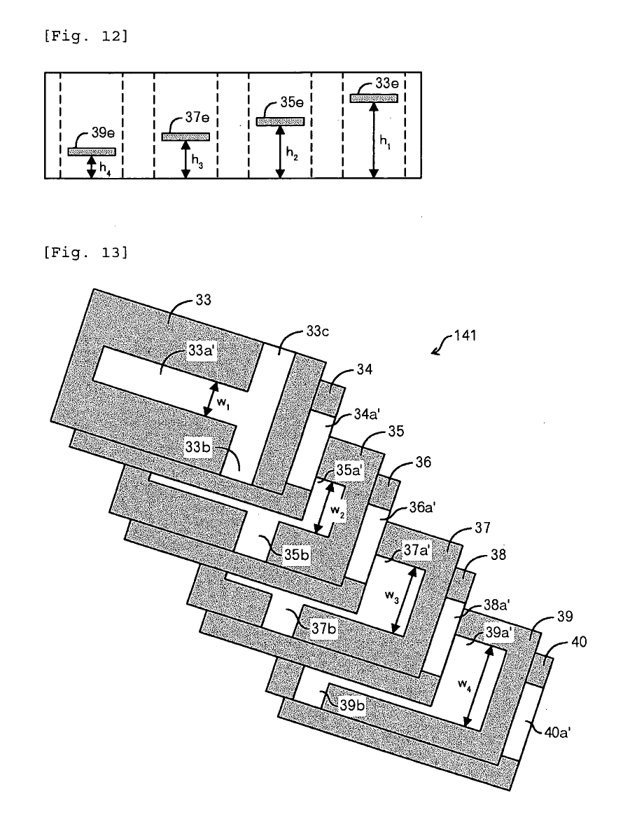

In this embodiment, in order to lessen such a variance of resonance frequencies, the configuration shown in FIG. 5 is changed to the configuration shown in FIG. 13. As is shown in an exploded perspective view of FIG. 13, a chip varistor 141 of this embodiment includes, from top to bottom, a ceramic layer 33 with an inner conductor containing a signal line 33a′ having a width (referred to also as length) w₁ formed on the top surface thereof, a ceramic layer 34 with an inner conductor 34a′ for grounding formed on the top surface thereof, a ceramic layer 35 with an inner conductor containing a signal line 35a′ having a width w₂ formed on the top surface thereof, a ceramic layer 36 with an inner conductor 36a′ for grounding formed on the top surface thereof, a ceramic layer 37 with an inner conductor containing a signal line 37a′ having a width w₃ formed on the top surface thereof, a ceramic layer 38 with an inner conductor 38a′ for grounding formed on the top surface thereof, a ceramic layer 39 with an inner conductor containing a signal line 39a′ having a width w₄ formed on the top surface thereof, and a ceramic layer 40 with an inner conductor 40a′ for grounding formed on the top surface thereof. Part of the layers is not shown in the drawing.

As can be understood from FIG. 13, the widths (or the lengths) of the signal lines have the relation expressed as w₁<w₂<w₃<w4. The width (or the length) of the signal line becomes shorter as the height from the packaging surface becomes higher (that is, farther from the packaging surface). By adjusting the width (or the length) of the signal line in this manner, the inductance can be adjust in each circuit. It is thus possible to lessen a variance of the resonance frequencies as is shown in FIG. 3.

Because the leading portions and the external electrodes are the same as their counterparts in FIG. 5, descriptions thereof are omitted herein.

It should be noted that the chip varistor 141 of this embodiment can be formed from materials same as those forming a multilayer chip varistor in the related art. The chip varistor 141 having the structure shown in FIG. 13 can be manufactured by the same technique for a typical multilayer ceramic varistor.

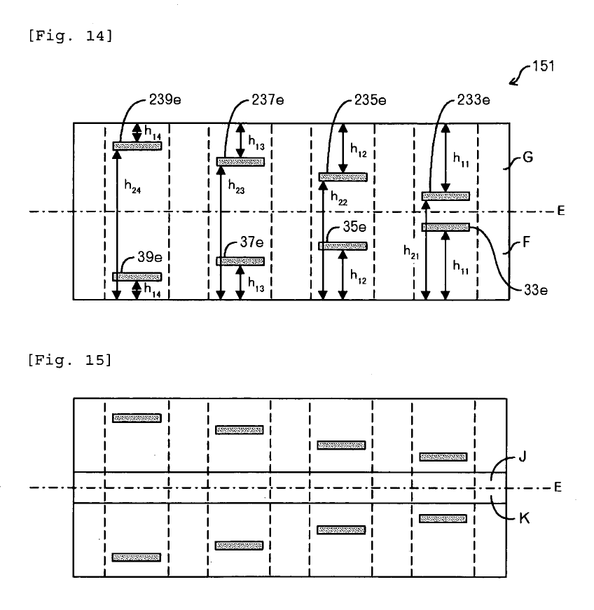

FIG. 14 is a view schematically showing the side surface of a chip varistor 151 according to this embodiment. In FIG. 14, assume that no external electrode has been formed. Referring to FIG. 14, a portion F below an alternate long and short dash line E has the same configuration as in the second or sixth embodiment. More specifically, assume that the bottom surface of the chip varistor 151 is the packaging surface to the printed circuit board or the like, then, the leading portion end 33e appears at the right end when viewed from the side surface at a height ₁₁ from the packaging surface. The leading portion end 35e appears second from the right at a height h₁₂ from the packaging surface. The leading portion end 37e appears third from the right at a height h₁₃ from the packaging surface. The leading portion end 39e appears at the left end at a height h₁₄ from the packaging surface. Herein, the relation expressed as h₁₁>h₁₂>h₁₃>h₁₄ is established.

A portion G above the alternate long and short dash line E of the chip varistor 151 has a layer structure symmetric with respect to the alternate long and short dash line E. A leading portion end 233e connected to the leading portion end 33e via the same external electrode is therefore provided at a height h₁₁ below the top surface of the chip varistor 151. The width (or the length) of a signal line inside the layer is the same in the both layers in which the leading portion ends 33e and 233e are connected to the external electrode. In addition, a leading portion end 235e connected to the leading portion end 35e via the same external electrode is provided at a height h₁₂ below the top surface of the chip varistor 151. The width (or the length) of a signal line inside the layer is the same in the both layers in which the leading portion ends 35e and 235e are connected to the external electrode. Further, a leading portion end 237e connected to the leading portion end 37e via the same external electrode is provided at a height h₁₃ below the top surface of the chip varistor 151. The width (or the length) of a signal line inside the layer is the same in the both layers in which the leading portion ends 37e and 237e are connected to the external electrode. Furthermore, a leading portion end 239e connected to the leading portion end 39e via the same external electrode is provided at a height h₁₄ below the top surface of the chip varistor 151. The width (or the length) of a signal line inside the layer is the same in the both layers in which the leading portion ends 39e and 239e are connected to the external electrode.

When configured in this manner, in a case where the bottom surface of the chip varistor 151 is the packaging surface, sums of heights from the packaging surface (height h₁₁ of the leading portion end 33e+height h₂₁ of the leading portion end 233e, height h₁₂ of the leading portion end 35e+height h₂₂ of the leading portion end 235e, height h₁₃ of the leading portion end 37e+height h₂₃ of the leading portion end 237e, height h₁₄ of the leading portion end 39e+height h₂₄ of the leading portion end 239e) are all nearly equal. The length of the leading line for each circuit therefore becomes nearly equal. It is thus possible to suppress a variance of resonance frequencies as shown inside the circle D in FIG. 3.

Because the length of the signal line is the same even when the top surface of the chip varistor 151 is the packaging surface, the chip varistor 151 can be readily packaged.

In a case where the thickness of the chip varistor 151 needs to be adjusted, as is shown in FIG. 15, dummy layers J and K of the same thickness are formed above and below the alternate long and short dash line E serving as the center line. It should be noted that when the thickness does not have to be adjusted, the dummy layers J and K can be omitted.

While embodiments of the invention have been described, it should be appreciated that the invention is not limited to these embodiments. For example, whether the number of circuits is increased in the lamination direction or whether the number of circuits is increased in the plane direction can be determined according to the packaging area and the thickness allowed for a chip varistor in question.

As has been described, it is possible to provide a compact chip varistor that achieves a countermeasure against static electricity and removal of an unwanted radiation signal, and is thereby capable of handling a multi-channel signal line.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope

What is claimed is:

1. A varistor, comprising:
a plurality of layer sets laminated on top of one another in a direction, each set comprising:
a ground conductor layer connected to an external electrode for grounding formed on a top surface of a first ceramic layer, and
a signal conductor layer comprising a leading portion connected to an external electrode for signal formed on a top surface of a second ceramic layer,
wherein the leading portions of different ones of the plurality of sets are displaced so as not to overlap one on anther in the direction in which the plurality of sets are laminated.

2. The varistor according to claim 1, wherein:
a surface on which the external electrode for grounding is formed and a surface on which the external electrode for signal is formed are orthogonal to each other.

3. The varistor according to claim 1, wherein each set further comprises:
a second ground conductor layer connected to the external electrode for grounding formed on a top surface of a third ceramic layer.

4. The varistor according to claim 1, wherein:
the signal conductor layer comprises a first signal conductor layer comprising a first leading portion connected to a first external electrode for signal, and a second signal conductor layer comprising a second leading portion connected to a second external electrode for signal formed on the same ceramic layer.

5. The varistor according to claim 1, wherein:
a signal line in the signal conductor layer becomes shorter as the height of the signal conductor layer from one of a bottom surface and a top surface of the varistor increases.

6. The varistor according to claim 1, further comprising:
a plurality of second layer sets laminated on top of one another in a second direction opposite to the direction in which the plurality of first sets are laminated, each second set comprising,
a second ground conductor layer connected to the external electrode for grounding formed on a bottom surface of a third ceramic layer, and
a second signal conductor layer comprising a leading portion connected to the external electrode for signal formed on a bottom surface of a fourth ceramic layer,
wherein the leading portions of different ones of the plurality of second sets are displaced so as not to overlap one on another in the second direction;
wherein a sum of heights of the leading portion in the first set and the leading portion in the second set from one of a top surface and a bottom surface of the varistor becomes equal for all combinations of the leading portion in the first set and the leading portion in the second set.
